(19) United States
(12) Patent Application Publication
(10) Pub. No.: US 2010/0061213 A1
(43) Pub. Date: Mar. 11, 2010

(54) OPTICAL HOLOGRAPHIC DEVICE AND METHOD WITH GAIN COMPENSATION

(75) Inventors: Floris Maria Hermansz Crompvoets, Eindhoven (NL); Frank Jeroen Pieter Schuurmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/441,444

(22) PCT Filed: Sep. 26, 2007
(86) PCT No.: PCT/IB07/53908

§ 371 Date: Mar. 16, 2009

(30) Foreign Application Priority Data
Sep. 29, 2006 (EP) 06121529.9

(51) Int. Cl. G11B 7/00

(52) U.S. Cl. 369/103; 369/116; 369/124.1; G9B/7; 369/124.1

(57) ABSTRACT

The present invention relates to an optical holographic device and a corresponding method for reading out a data page recorded in a holographic recording medium (106). In order to improve the bit error rate a reconstruction means (115) provided for reconstructing a dark and a light image from a separate checkerboard page comprising a pattern of dark and light pixels or from the detected imaged data page, and an image correction means (116) is provided for correcting said detected imaged data page by gain compensation using said reconstructed dark and light images.

### FIELD OF THE INVENTION

The present invention relates to an optical holographic device and a corresponding method for reading out a data page recorded in a holographic recording medium. Further, the present invention relates to an electronic device and a corresponding method for use in such an optical holographic device. Finally, the present invention relates to a computer program for implementing said methods in software.

### BACKGROUND OF THE INVENTION

Holographic Data Storage Systems (HDSS) promise high data capacities (1 TByte on a 12-cm disc) and high data rates (Gbit/s). The advantage of holographic data storage over conventional optical storage is that it uses the real 3D volume of the medium to store the data making high capacities possible. An overview of Holographic Data Storage Systems are given in “Holographic Data Storage Systems”, Lambertus Hesselink, Sergei S. Orlov, and Matthew C. Bashaw, Proceedings of the IEEE, vol. 92, no. 8, pp. 1231-1280, 2004.

Most holographic data storage systems that are currently known use a so-called page based storage system. In these systems the pages or images are read out by an image detector (for instance a CCD or CMOS chip). Non-uniformities in the image detectors or in the profiles of the laser beams, which are used for writing and reading, make it more difficult to tell which pixels represent a bit value of 0 or a bit value of 1. To detect such errors, some methods have been proposed, e.g. in U.S. Pat. No. 5,838,650, that make use of alignment marks embedded in the holographic medium. They are detected and the holographic medium is translated and rotated until the right alignment marks are retrieved on the detector. However, such a detection method is not suitable for a high-density holographic medium, because the alignment marks require space in the holographic medium, which reduces the possible data density. Another method, described in WO 2005/057584 A1, proposes to detect a Moire pattern in the detected imaged data page and to modify the imaged data page as a function of the Moire pattern.

### SUMMARY OF THE INVENTION

It is an object of the present invention to provide an optical holographic device and a corresponding method for reading out a data page recorded in a holographic recording medium having improved abilities to correct the described errors and to correctly detect the bits, in particular for improving the bit error rate. It is a further object to provide an electronic device and a corresponding method for use in such an optical holographic device and to provide a computer program for implementing said methods.

The object is achieved according to the present invention by an optical holographic device as defined in claim 1, said device comprising:

image forming means for forming an imaged data page,

image detection means for detecting said imaged data page,

reconstruction means for reconstructing a dark and a light image from a separate checkerboard page comprising a pattern of dark and light pixels or from said detected imaged data page, and

image correction means for correcting said detected imaged data page by gain compensation using said reconstructed dark and light images

The object is further achieved according to the present invention by an electronic device as defined in claim 9, said electronic device comprising:

reconstruction means for reconstructing a dark and a light image from a separate checkerboard page comprising a pattern of dark and light pixels or from said detected imaged data page, and

image correction means for correcting said detected imaged data page by gain compensation using said reconstructed dark and light images.

The object is still further achieved according to the present invention by a computer program comprising program code means for causing a computer to carry out the steps of the method as claimed in claim 10 or 11, when said computer program is carried out on a computer.

Corresponding methods are defined in further independent claims. Preferred embodiments of the invention are defined in the dependent claims. It shall be understood that the electronic device, the methods and the computer program have similar and/or identical preferred embodiments as defined in the dependent claims.

The present invention is based on the idea to extract the described non-uniformities from the detected image itself or from a separate checkerboard page. This information is then used for gain compensation of the individual pixels over the entire image, which finally improves the bit detection.

In holographic data storage systems data is stored in a medium as the interference pattern created by two laser beams. One beam contains the data and one beam is used as a reference to create the interference pattern. Spatial light intensity fluctuations in the laser beams during writing of the data, as well as during read-out, lead to unwanted variations in the acquired image upon read-out. Also the non-uniform pixel response of the image detector adds to these unwanted variations. In addition, the medium in which the data is written might scatter the laser light inhomogeneously, making the intensity fluctuations in the image even more severe. These variations make it difficult to determine a slicer level to tell which pixels represent a ‘0’ and which pixels represent a ‘1’. For instance, the pixel value representing a ‘0’ in one part of the image can be the same as the pixel value representing a ‘1’ in another part of the image.

Thus, a separate dark image (e.g. all bits having bit value ‘0’) and a light image (e.g. all bits having bit value ‘1’) are taken to compensate for the non-uniform pixel response of the detector and the laser beam fluctuations, respectively. If the medium in the ideal case scatters isotropically, then these images would be sufficient to correct all data pages read out from the medium. In practice, however, the medium does not scatter isotropically over the entire medium volume and these dark and light images should be retrieved more frequently to compensate for anisotropical scattering. This leads to the reduction of storage space for user data and hence data density. It is therefore advantageous to reduce the number of dark and light pages.

It is thus further proposed to use, instead of a separate dark page and a separate light (white) page, the two pages interleaved into one page or to retrieve the two pages directly from a detected imaged data page. A completely light page and a completely dark page will be reconstructed therefrom, and these reconstructed dark and light pages are then used for gain compensation of user data pages. The fluctuations in the light pixel values and the dark pixel values are thus reduced. This improves the bit recognition and hence the bit error rate (BER).

Preferably, the gain compensation is done such that the dark image is subtracted from the detected imaged data page and the resulting image is divided by the light image to obtain the corrected image data page.

According to one preferred embodiment a dark and a light image are reconstructed from a separate checkerboard page comprising a pattern of dark and light pixels by measuring said dark and light pixels in said checkerboard page and by interpolating missing pixels between said measured dark and light pixels to obtain completely dark and light images. Said checkerboard page preferably comprises a regular pattern of dark and light pixels. For instance, blocks of dark and light pixels are alternately arranged in a (preferably periodic) pattern over the entire checkerboard page. By first deinterleaving the dark and light pixels and subsequently interpolating the missing information the dark image and the light image are derived for use in the subsequent gain compensation.

Alternatively, the dark image and the light image are directly extracted from the detected imaged data page reducing the overhead compared to the embodiment using a checkerboard page considerably.

According to a first embodiment employing said idea said reconstruction means comprises

a pixel value determination unit for determining the bit values of the pixels of the detected imaged data page, in particular by slicer level detection,

a dark and light image determination unit for determining a dark image by selecting only the pixels having a first bit value as dark pixels and for determining a light image by selecting only the pixels having a second bit value different from the first bit value as light pixels,

an image processing unit for low pass filtering said dark image and said light image, said low pass filtered dark image and said low pass filtered light image being used for correcting said detected imaged data page,

a check unit for checking whether a predetermined stop criterion has been met, and

a parameter setting unit for changing the cut-off frequency used for low pass filtering said dark image and said light image by said image processing unit if said predetermined stop criterion has not been met,

wherein said reconstruction of said a dark and light image is interactively carried out until said predetermined criterion has been met.

According to a second embodiment employing said idea said reconstruction means comprises

a pixel value determination unit for determining the bit values of the pixels of the detected imaged data page, in particular by slicer level detection,

a dark and light image determination unit for determining a dark image by selecting only the pixels having a first bit value as dark pixels and for determining a light image by selecting only the pixels having a second bit value different from the first bit value as light pixels,

an image processing unit for selecting an area of said dark image and said light image, for averaging the bit values of the pixels in said area selected as dark pixels and for averaging the bit values of the pixels in said area selected as light pixels to obtain an averaged dark image and an averaged light image being used for correcting said detected imaged data page,

a check unit for checking whether a predetermined stop criterion has been met, and

a parameter setting unit for changing the size and/or position of said area in said dark image and said light image used by said image processing unit, if said predetermined stop criterion has not been met,

wherein said reconstruction of said a dark and light image is interactively carried out until said predetermined criterion has been met.

Basically, according to said embodiments, mathematically a convolution is taken between the detected imaged data page and a user-defined window, the size of which determines the cut-off frequency. Generally holds, the smaller the size of the window with respect to the size of the entire data page the higher the cut-off frequency.

Initially, the bit values of the pixels of the complete detected imaged data page are determined, in particular by slicer level detection for use in the subsequent steps of the iterative reconstruction of the dark and light images.

According to both embodiments in the dark and light image determination unit dark pixel are determined by selecting only the pixels having a first bit value and light pixels are determined by selecting only the pixels having a second bit value different from the first bit value. Here, a first or second bit value, respectively, means a first range of bit values, e.g. below a threshold, and a second range of bit values, e.g. above said threshold.

In said embodiments it is preferred that said check unit is adapted for checking whether the bit error rate has increased in the corrected imaged detected data page and that said parameter setting unit is adapted for increasing the cut-off frequency or reducing the size of said area, respectively, if said bit error rate has decreased, and for decreasing the cut-off frequency or increasing the size of said area, respectively, if said bit error rate has increased.

Generally, however, different criteria can be used as said predetermined criterion, i.e. it can be set by the user. Preferred criteria are a predetermined number of iterations, a predetermined bit error rate or a predetermined cut-off frequency or size of said area, respectively.

### BRIEF DESCRIPTION OF THE DRAWINGS

The invention will now be explained in more detail with reference to the drawings in which

FIG. 1 shows an optical holographic device according to the present invention,

FIG. 2 illustrates the reconstruction of a dark and a light image according to a first embodiment of the present invention,

FIG. 3 illustrates the use of a checkerboard page according to said first embodiment of the present invention,

FIG. 4 shows a reconstruction unit of an optical holographic device according to a second embodiment of the present invention,

FIG. 5 illustrates the reconstruction of a dark and a light image according to said second embodiment, and

FIG. 6 shows a flow chart illustrating the main steps of the reconstruction according to another embodiment.

### DETAILED DESCRIPTION OF EMBODIMENTS

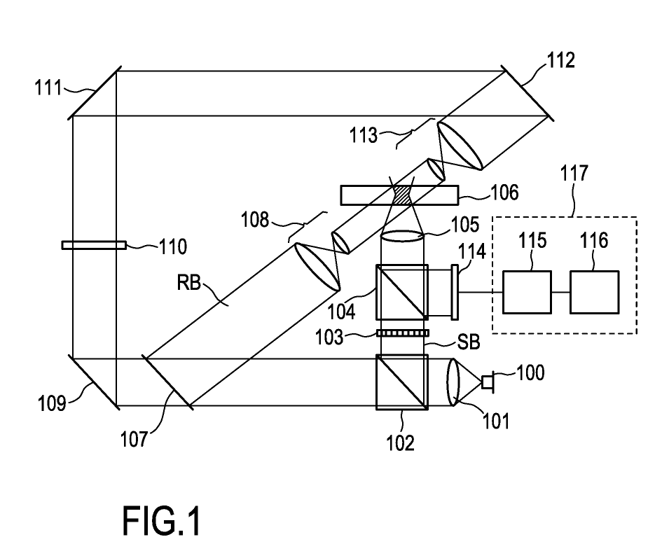

FIG. 1 shows an optical holographic device according to the present invention using phase conjugate read out. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113, a detector 114, a reconstruction unit 115 and an image correction unit 116. The optical device is intended to record in and read data from a holographic medium 106.

The reconstruction unit 115 and the image correction unit 116 preferably form an electronic device 117, such as a dedicated integrated circuit or other hardware, that is separately distributed and that can, for instance, be added to existing holographic optical devices. Alternatively, the functions of the reconstruction unit 115 and the image correction unit 116 can also be implemented in software running, e.g., on a computer or a microprocessor.

During recording of a data page in the holographic medium 106, half of the radiation beam generated by the radiation source 100 is sent towards the spatial light modulator 103 by means of the first beam splitter 102. This portion of the radiation beam is called the signal beam SB. Half of the radiation beam generated by the radiation source 100 is deflected towards the telescope 108 by means of the first deflector 107. This portion of the radiation beam is called the reference beam RB. The signal beam SB is spatially modulated by means of the spatial light modulator 103. The spatial light modulator 103 comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam RB is also focused on the holographic medium 106 by means of the first telescope 108. The data page is thus recorded in the holographic medium 106, in the form of an interference pattern as a result of interference between the signal beam SB and the reference beam RB. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam RB at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kinds of multiplexing, such as shift multiplexing, may also be used for recording data pages in the holographic medium 106. Such multiplexing techniques are also described in the above-cited document “Holographic Data Storage Systems”.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels. While in one embodiment each pixel corresponds to a bit of the imaged data page, in another embodiment (which is preferred here) the detector 114 has more pixels than the imaged data page, i.e. the image is oversampled by the detector 114. In any case, the imaged data page should be carefully aligned with the detector 114, in such a way that one bit or a given number of bits of the imaged data page impinges on the corresponding pixel of the detector 114.

Now, there are many degrees of freedom in the system, so that the imaged data page is not always carefully aligned with the detector 114. For example, a displacement of the holographic medium 106 with respect to the detector 114, in a direction perpendicular to the axis of the reconstructed signal beam, leads to a translational misalignment. A rotation of the holographic medium 106 or the detector 114 leads to an angular error between the imaged data page and the detector 114. A displacement of the holographic medium 106 with respect to the detector 114, in a direction parallel to the axis of the reconstructed signal beam, leads to a magnification error, which means that the size of a bit (or a give number of bits) of the imaged data page is different from the size of a pixel of the detector 114.

Further, as explained above, spatial light intensity fluctuations in the laser beams during writing of the data, as well as during read-out, lead to unwanted variations in the acquired image upon read-out. Still further, the non-uniform pixel response of the image detector 114 adds to these unwanted variations. In addition, the holographic medium 106 might scatter the laser light inhomogeneously, making the intensity fluctuations in the image even more severe. These variations make correct bit detection difficult.

Hence, according to the present invention, a reconstruction unit 115 is provided for reconstructing a dark image (e.g. all bits having bit value ‘0’) and a light image (e.g. all bits having bit value ‘1’) from a separate checkerboard page comprising a pattern of dark and light pixels or from said detected imaged data page, and an image correction unit 116 is provided for correcting said detected imaged data page by gain compensation using said reconstructed dark and light images. Thus, a compensate of the non-uniform pixel response of the detector 114 and the laser beam fluctuations, respectively, is obtained.

If the medium in the ideal case scatters isotropically, then one dark image and one light image would be sufficient to correct all data pages read out from the medium 106. In practice, however, the medium 106 does not scatter isotropically over the entire medium volume and these dark and light images need to be retrieved more frequently to compensate for anisotropical scattering. This leads to the reduction of storage space for user data and hence data density.

To reduce the number of dark and light pages it is further proposed to interleave the two pages into one (specifically provided) page, which is stored along with the data pages on the medium 106, which is then read-out separately and used for image correction, or to retrieve the two pages directly from a detected imaged data page. A completely light page and a completely dark page will be reconstructed therefrom in the reconstruction unit, and these reconstructed dark and light pages are then used for gain compensation of user data pages in the image correction unit 116. The fluctuations in the light pixel values and the dark pixel values are thus reduced. This improves the bit recognition and hence the bit error rate (BER).

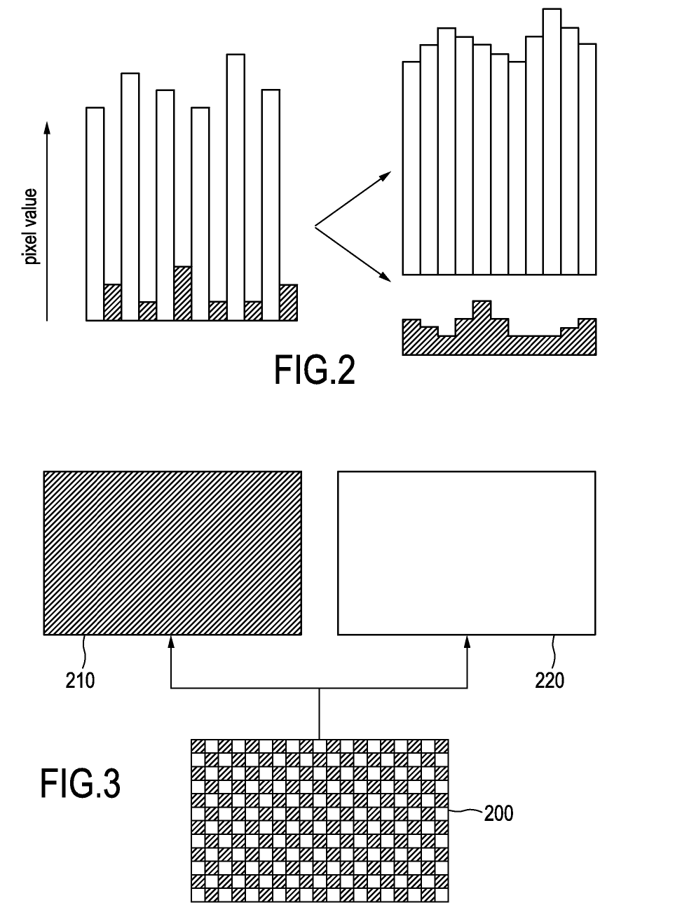

FIG. 2 illustrates the reconstruction of a dark and a light image according to a first embodiment of the present invention from a checkerboard page in which blocks of dark and light pixels (or single dark and white pixels) are alternately arranged (interleaved') in a (preferably periodic) pattern over the entire checkerboard page. The dark pixels and light pixels are measured during read-out and de-interleaved, and the missing information is obtained by interpolation. The left part of FIG. 2 shows the interleaved dark and light pixels in a row of the image. After deinterleaving (right part) the missing dark and white pixels are reconstructed by interpolation. Said deinterleaving of a checkerboard page 200 into a dark image 210 and a light image 220 is also schematically illustrated in FIG. 3.

For the interpolation several methods can be used, such as linear interpolation or interpolation using splines. The accuracy of the interpolation depends on the size of the checkers: the smaller the checkers the better the interpolation. There is a trade-off between the size of the checkers, and hence the accuracy of the interpolation, and how well the checkers can still be recognized as dark or light blocks of pixels. The periodic pattern of the checkerboard helps greatly to determine which pixel blocks are dark and which pixel blocks are light. If the origin of the image as well as the orientation and the size of the checkers is specified, for instance in a standard, then the position of the next block of pixels can be determined very accurately.

Once the light and the dark images are reconstructed they are used to correct the data images by gain compensation. First the dark image is subtracted from the data image and the resulting image is then normalized by dividing it by the light image: corrected image=(raw image−dark image)/(light image).

The checkerboard pattern is an excellent solution when the holographic data storage system is such that it requires only one dark image and one white image per book.

Typical pages (images) per book are in the range of a few hundred (˜200) so the overhead of only one checkerboard page can be neglected. However, due to medium imperfections it might be necessary to obtain a dark and a light image for every data page separately. In this case 200 checkerboard pages would be needed for 200 data pages leading to an undesirably large overhead. This overhead can be practically eliminated by extracting a dark image and a light image directly from the data page itself, as proposed according to a further embodiment of the present invention, because the information about the variations in the images is embedded in the images themselves.

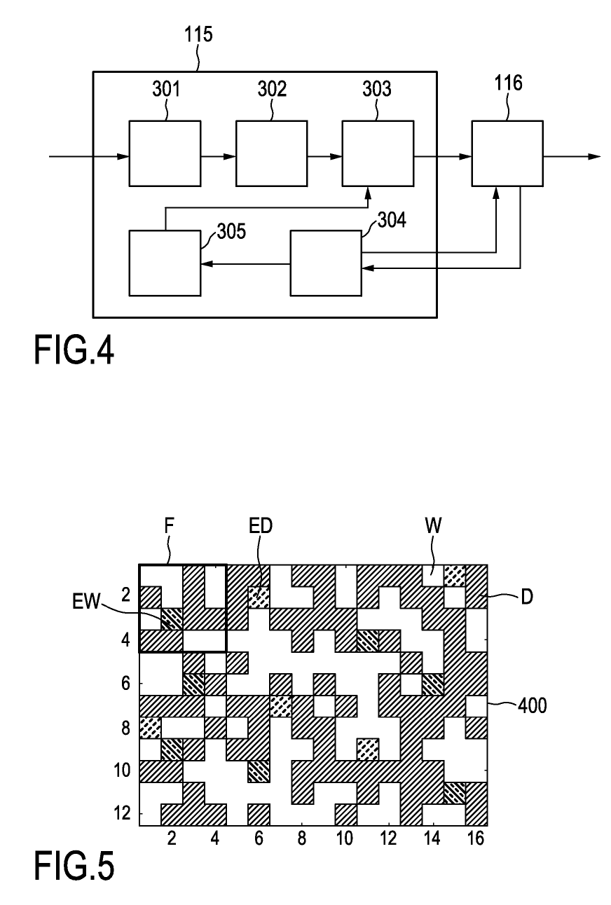

An embodiment of a reconstruction unit 115 according to this embodiment for use in the optical holographic device shown in FIG. 1 is schematically shown in FIG. 4. Therein, the extraction of the dark and white pages is done in a few iterative steps.

First, in a pixel value determination unit 301 the bit values of the pixels of the detected imaged data page are detected, in particular by slicer level detection. It is thus determined which pixels are light and which pixels are dark as good as possible, as shown by the cross-hatched blocks D and the white blocks W of the imaged detected data page 400 shown in FIG. 5. Once this is done, in a dark and light image determination unit 302 a dark image is extracted from the image by only considering the pixels that have been given a first bit value, e.g. of ‘0’, and similarly a light image is extracted by only considering the pixels that have been given a second bit value (different from the first bit value), e.g. of ‘1’.

However, in the first iteration step some pixels can be wrongly determined by said pixel value determination unit 301 as indicated in FIG. 5, where EW indicates wrongly determined light pixels and ED indicates wrongly determined dark pixels. In order to prevent the propagation of these bit errors through the iteration process a group of light pixels (or dark pixels) is averaged so that all the light (or dark) pixels have the same value and the influence of the erroneous pixel values is strongly reduced. This is done in an image processing unit 303, preferably by low pass filtering the constructed light (or dark) images, for instance by averaging a 4-by-4 group of pixels. The dark and light images that are created in this way are then used to correct the data image, in particular using said image correction unit 116.

In a check unit 304 it is then checked whether a predetermined stop criterion has been met. Such stop criteria can, for instance, be a predetermined number of iterations, a predetermined bit error rate or a predetermined cut-off frequency or size of said area, respectively. For instance, the iteration continues until the error correction (not shown) of the device can handle the remaining bit errors.

If the predetermined stop criterion has been met, a corresponding signal is fed back to the image correction unit 116 to use the corrected image as final image and to output it.

If the predetermined stop criterion has not been met, a corresponding signal is fed to a parameter setting unit 305 to increase the cut-off frequency of the low pass filter in the next iterative step (for instance averaging over a 3-by-3 group of pixels) as less bit errors are expected. Again a light and a dark image are reconstructed and applied to the data image. Compared to the checkerboard pattern method this method requires more time due to the iteration process but it greatly reduces the overhead.

The above steps are carried out iteratively until said predetermined criterion has been met.

According to another, quite similar embodiment the reconstruction unit 115 generally has the same units, but the image processing unit 303 is adapted for selecting said area F of said detected imaged data page 400 directly. In particular, the image processing unit 303 directly selects an area of said dark image and said light image, averages the bit values of the pixels in said area selected as dark pixels and averages the bit values of the pixels in said area selected as light pixels to obtain an averaged dark image and an averaged light image, which are then used for correcting said detected imaged data page. Further, the parameter setting unit 305 is adapted for changing the size and/or position of said area in said dark image and said light image used by said image processing unit 303, if said predetermined stop criterion has not been met. All other steps and units are identical or at least equivalent to the steps and units as in the embodiment explained above with reference to FIG. 4.

Preferably, the check unit is adapted for checking whether the bit error rate has increased in the corrected imaged detected data page and the parameter setting unit 305 is adapted for increasing the cut-off frequency or reducing the size of said area, respectively, if said bit error rate has decreased, and for decreasing the cut-off frequency or increasing the size of said area, respectively, if said bit error rate has increased.

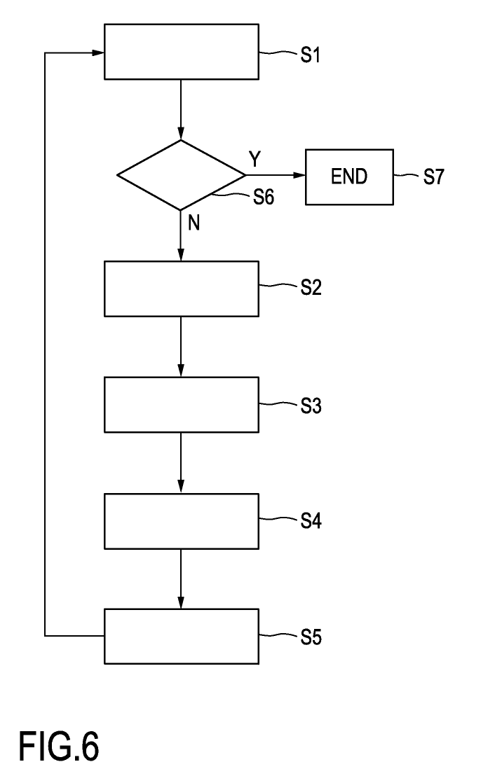

The flow chart shown in FIG. 6 also illustrates the main steps of a preferred embodiment of the present invention. In a first step S1 it is determined which pixels are light and which pixels are dark in the data image. However, some of these pixels are wrongly determined as dark or light. Then, in step S2 a group of, for instance, 6×6 pixels is determined in the data image. Of this group the average value of all light determined pixels is taken in step S3 and this value is assigned to each of the corresponding 6×6 pixels in the light image. This averaging, or low pass filtering (averaging window=6×6), is done to reduce the contribution of the erroneously determined pixels. A similar procedure is repeated in step S4 for the dark pixels. In this way a dark and light image are created that are subsequently (step S5) used to normalized (correct) the data image.

The next step is going back to the first step S1: It is again determined which pixels are light and which pixels are dark. If the bit error rate is sufficiently low, which is checked in step S6 (which is left out in the first iteration, or in other words the error correction scheme can handle the bit errors then the iteration will be stopped (step S7). Otherwise, new dark and light images are created based on a different averaging window in steps S3 and S4. If the bit error rate is higher now, then it also is possible to choose a larger averaging window (e.g. 8×8 pixels), i.e. a lower cut-off frequency. If the bit error rate is lower (better), then choose a smaller averaging window (e.g. 5×5 or 4×4 pixels) is chosen. So the averaging window or cut-off frequency adapts itself to the bit error rate in this embodiment.

While the invention has been illustrated and described in detail in the drawings and foregoing description, such illustration and description are to be considered illustrative or exemplary and not restrictive; the invention is not limited to the disclosed embodiments. Generally, the idea underlying the present invention cannot only applied in holographic data storage systems but also in other fields where image processing requires flat fielding and dark current correction.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Optical holographic device for reading out a data page recorded in a holographic recording medium (106), said device comprising:
image forming means (104, 105) for forming an imaged data page,
image detection means (114) for detecting said imaged data page,
reconstruction means (115) for reconstructing a dark and a light image from a separate checkerboard page (200) comprising a pattern of dark and light pixels or from said detected imaged data page (400), and
image correction means (116) for correcting said detected imaged data page by gain compensation using said reconstructed dark and light images.

2. Optical holographic device as claimed in claim 1,
wherein said image correction means (116) are adapted for subtracting the dark image from the detected imaged data page and dividing the resulting image by said light image to obtain a corrected image data page.

3. Optical holographic device as claimed in claim 1,
wherein said reconstruction means (115) are adapted for reconstructing a dark and a light image from a separate checkerboard page (200) comprising a pattern of dark and light pixels by measuring said dark and light pixels in said checkerboard page and by interpolating missing pixels between said measured dark and light pixels to obtain completely dark and light images.

4. Optical holographic device as claimed in claim 1,
wherein said checkerboard page (200) comprises a regular pattern of dark and light pixels.

5. Optical holographic device as claimed in claim 1,
wherein said reconstruction means (115) comprises
a pixel value determination unit (301) for determining the bit values of the pixels of the detected imaged data page, in particular by slicer level detection,
a dark and light image determination unit (302) for determining a dark image by selecting only the pixels having a first bit value as dark pixels and for determining a light image by selecting only the pixels having a second bit value different from the first bit value as light pixels,
an image processing unit (303) for low pass filtering said dark image and said light image, said low pass filtered dark image and said low pass filtered light image being used for correcting said detected imaged data page,
a check unit (304) for checking whether a predetermined stop criterion has been met, and
a parameter setting unit (305) for changing the cut-off frequency used for low pass filtering said dark image and said light image by said image processing unit if said predetermined stop criterion has not been met,
wherein said reconstruction of said a dark and light image is interactively carried out until said predetermined criterion has been met.

6. Optical holographic device as claimed in claim 1,
wherein said reconstruction means (115) comprises
a pixel value determination unit (301) for determining the bit values of the pixels of the detected imaged data page, in particular by slicer level detection,
a dark and light image determination unit (302) for determining a dark image by selecting only the pixels having a first bit value as dark pixels and for determining a light image by selecting only the pixels having a second bit value different from the first bit value as light pixels,
an image processing unit (303) for selecting an area of said dark image and said light image, for averaging the bit values of the pixels in said area selected as dark pixels and for averaging the bit values of the pixels in said area selected as light pixels to obtain an averaged dark image and an averaged light image being used for correcting said detected imaged data page,
a check unit (304) for checking whether a predetermined stop criterion has been met, and
a parameter setting unit (305) for changing the size and/or position of said area in said dark image and said light image used by said image processing unit, if said predetermined stop criterion has not been met,
wherein said reconstruction of said a dark and light image is interactively carried out until said predetermined criterion has been met.

7. Optical holographic device as claimed in claim 5,
wherein said check unit (304) is adapted for checking whether the bit error rate has increased in the corrected imaged detected data page and
wherein said parameter setting unit (305) is adapted for increasing the cut-off frequency or reducing the size of said area, respectively, if said bit error rate has decreased, and for decreasing the cut-off frequency or increasing the size of said area, respectively, if said bit error rate has increased.

8. Optical holographic device as claimed in claim 5,
wherein check unit (304) is adapted to apply as said predetermined criterion a predetermined number of iterations, a predetermined bit error rate or a predetermined cut-off frequency or size of said area, respectively.

9. Electronic device (117) for use in an optical holographic device for reading out a data page recorded in a holographic recording medium (106) as defined in claim 1, wherein said optical device holographic device comprises image forming means (104, 105) for forming an imaged data page and image detection means (114) for detecting said imaged data page, said electronic device comprising:
reconstruction means (115) for reconstructing a dark and a light image from a separate checkerboard page comprising a pattern of dark and light pixels or from said detected imaged data page, and
image correction means (116) for correcting said detected imaged data page by gain compensation using said reconstructed dark and light images.

10. Method for reading out a data page recorded in a holographic recording medium (106), said method comprising the steps of:
forming an imaged data page,
detecting said imaged data page,
reconstructing a dark and a light image from a separate checkerboard page comprising a pattern of dark and light pixels or from said detected imaged data page, and
correcting said detected imaged data page by gain compensation using said reconstructed dark and light images.

11. Method for use in an optical holographic device for reading out a data page recorded in a holographic recording medium (106) as defined in claim 1, wherein said optical device holographic device comprises image forming means (104, 105) for forming an imaged data page and image detection means (114) for detecting said imaged data page, said method comprising the steps of:
reconstructing a dark and a light image from a separate checkerboard page comprising a pattern of dark and light pixels or from said detected imaged data page, and
for correcting said detected imaged data page by gain compensation using said reconstructed dark and light images.

12. Computer program comprising program code means for causing a computer to carry out the steps of the method as claimed in claim 10, when said computer program is carried out on a computer.
